(19) United States
(12) Patent Application Publication
(10) Pub. No.: US 2006/0050938 A1
(43) Pub. Date: Mar. 9, 2006

(54) Method and device for improving the representation of CT recordings

(76) Inventor: Rainer Raupach, Adelsdorf (DE)

Correspondence Address: HARNESS, DICKEY & PIERCE, P.L.C., P.O.BOX 8910, RESTON, VA, 20195, US

(21) Appl. No.: 11/203,105

(22) Filed: Aug. 15, 2005

(30) Foreign Application Priority Data
Sep. 3, 2004 (DE) 10 2004 042 792.5

(51) Int. Cl. G06K 9/00

(52) U.S. Cl. 382/127

(57) ABSTRACT

A method and a device are disclosed for improving visual recognition in medical images with a large brightness range. This can be done, for example, by electronic manipulation of the represented brightness values, wherein the image has regions with essentially two different brightness intervals. By application of nonlinear scaling, followed by contrast enhancement and subsequent resealing of the image values, structures are represented with a richer contrast without having to tolerate quality losses in the region of originally strong contrasts.

The present application hereby claims priority under 35 U.S.C. §119 on German patent application number DE 10 2004 042 792.5 filed Sep. 3, 2004, the entire contents of which is hereby incorporated herein by reference.

### FIELD

The invention generally relates to a method and/or a device for improving visual recognition in medical images with a large brightness range. This may be done, for example, by electronic manipulation of the represented brightness values, especially in X-ray or CT images, in which the brightness of a pixel corresponds to the absorption values of the exposed object. The image may represent at least soft substructures and bone structures and correspondingly may have image regions with essentially two different brightness intervals, wherein a first brightness interval corresponds to the bone structure and a second brightness interval corresponds to the soft substructure.

### BACKGROUND

Generally, methods and devices for improving image quality in the image processing of medical representations are widely known, especially in the CT field. One possibility resides in applying a so-called cupping correction in order to correct particular physical effects such as scattered radiation, extra-focal radiation or the like, in the convolution kernels used for the reconstruction of a CT image. This is essentially a filter which raises high spatial frequencies, although the steepest gradient lies at relatively low spatial frequencies. This correction cannot be applied arbitrary strongly since excessive amplification of the cupping correction leads to undesirable effects at edges with high contrasts, and the recognition of the structures therefore suffers greatly.

### SUMMARY

It is therefore an object of at least one embodiment of the invention to provide a method and/or a device for improving visual recognition in medical images with a large brightness range. Such a method/device may reduce or even avoid at least one of the aforementioned negative effects.

The Inventor, in at least one embodiment, has found that medical images, especially CT images, are distinguished in that they have at least two typical image regions, i.e. the representation of bones on the one hand and soft parts on the other hand, these respectively having a limited and sometimes relatively narrow brightness range but being relatively far apart from each other with respect to their average brightness value. Herein lies the filtering problem. This problem can be alleviated, however, if the two brightness intervals are brought close together without overlapping, contrast enhancement is carried out thereon and the brightness intervals are subsequently returned to the initial state, in which case an increased contrast is retained.

The Inventor, in at least one embodiment, proposes to improve on a method for improving visual recognition in medical images with a large brightness range by electronic manipulation of the represented brightness values, especially in X-ray or CT images, in which the brightness of a pixel corresponds to the absorption values of the exposed object, the image representing at least soft substructures and bone structures and correspondingly having image regions with essentially two different brightness intervals, wherein a first brightness interval corresponds to the bone structure and a second brightness interval corresponds to the soft substructure.

In at least one embodiment, a method includes:

an original image B with the pixel values I(x,y) is mapped by nonlinear scaling G onto a first intermediate image G(B) so that the contrast of the first brightness interval H₁ approximates the contrast of the second brightness interval H₂ and a modified first brightness interval H₁′ is obtained from the first brightness interval H₁;

a contrast enhancing filter F is applied to the first intermediate image Z₁=G(B), so as to obtain a second intermediate image Z₂=F(G(B));

nonlinear resealing H is applied to the second intermediate image Z₂=F(G(B)), which raises the modified first brightness interval H₁′ again with respect to its contrast and generates a first result image E₁=H(F(G(B))) with the pixel values I^{E}₁(x,y).

In this way in at least one embodiment, the contrast range of the overall image is firstly reduced to a relatively narrow but nonlinear range and contrast enhancement is carried out over the remaining brightness interval, and the brightness values are subsequently spread nonlinearly so that, with respect to the overall contrast range, the original impression of the image is retained but a region of particular interest has its contrast improved and the recognition of individual structures is enhanced.

Especially when using a not strictly monotonic mapping function in the nonlinear scaling, it is preferable in at least one embodiment, to generate a second result image E₂ with the pixel values I′(x,y), which is then regarded as the final image, by adaptive superposition from the first result image E₁ and the original image B.

Although in principle it is possible to use a one-dimensional filter F, in which case this may need to be applied repeatedly with different directions, it is nevertheless particularly preferable in at least one embodiment, for the filter F used to be designed as a two-dimensional filter.

It is likewise expedient for the filter F used to have an isotropic property.

In order to enhance the contrast in the image, a filter whose filter amplitude begins low in a lower spatial frequency range, and increases monotonically to higher spatial frequencies, may be used as the filter F.

For scaling and resealing the brightness values of the image in question, it is particularly expedient in at least one embodiment, to use nonlinear scalings G and H which are the inverses of each other and: G=H⁻¹. This is particularly applicable to the case when G is bijective.

For the nonlinear scalings G and H, preferably when G is non-bijective, it is preferable in at least one embodiment, for H to fulfill the property “G·H=identity”, i.e. the combination of G and H is the identical mapping. H therefore represents the inverse mapping of G restricted to the image set of G.

In the case of adaptive superposition of the images B and E₁, it is furthermore possible to carry out a pixel value-dependent weighting, for CT images preferably a HU value-dependent weighting, so that the effect of the contrast enhancement can be restricted particularly to the soft subregion.

For example, such adaptive superposition with HU-dependent weighting may be carried out according to the following formula:
I′(x,y)=φ(I(x,y))·I^{E}^{₁}(x,y)+[1−φ(I(x,y))]·I(x,y).

In a particular variant of the method in at least one embodiment, the nonlinear scaling may be carried out so that the second brightness interval is mapped into itself and therefore remains unchanged.

In another variant of the method according to at least one embodiment of the invention, the image treated may have a third brightness interval which corresponds e.g. to the recording of air, and this third brightness interval is treated similarly as the first brightness interval, although the direction of the scaling is the opposite.

The second brightness interval may, for example, lie in an interval of HU values from −20 to +80 HU, the first brightness interval containing the HU values lying below this and the third brightness interval containing the HU values lying above this.

Correspondingly to the basic idea of at least one embodiment of the invention, a device is proposed for improving visual recognition in medical images with a large brightness range, especially in X-ray or CT images, wherein the image represents at least both soft substructures and bone structures, electronic manipulation of the represented brightness values takes place. Further elements or modules, preferably programs or program modules, may be implemented for carrying out the method steps in at least one embodiment, as described above.

### BRIEF DESCRIPTION OF THE DRAWINGS

The invention will be described in more detail below with reference to example embodiments with the aid of the figures, although it should be pointed out that only the parts essential for directly understanding the embodiments of invention are shown. The following references are used: 1: soft substructure, 2: bone structure, 3: air, B: original image, C: HU value interval, G: scaling function, H: resealing function, Eₓ: result image, I(x,y): pixel values at the position (x,y), P: brightness values of the pixels, U: pixel values of the original image in HU units, x: position coordinates of the pixels in the direction of the x axis, y: position coordinates of the pixels in the direction of the y axis, Z: target range of the pixel values in HU units after the scaling, I: scaling, II: contrast increase/filtering, III: descaling, IV: adaptive superposition, λ: filter amplitude, ν: spatial frequency.

In detail:

FIG. 1 shows a representation of the frequency excursion of a typical cupping filter F;

FIG. 2 shows a schematic representation of a contrast jump before and after treatment with a cupping filter;

FIG. 3 shows a CT section image of a skull without image processing;

FIG. 4 shows a CT section image of a skull from FIG. 3 with the application of a strong cupping filter;

FIG. 5 shows an example of a nonlinear, strictly monotonic scaling function G;

FIG. 6 shows an example of a nonlinear and monotonic scaling function G;

FIG. 7 shows a flow chart of a method according to the invention;

FIG. 8 shows a CT section image of a skull without image processing (identical to FIG. 3);

FIG. 9 shows a CT section image of a skull from FIG. 8 with the application of image processing according to an embodiment of the invention.

### DETAILED DESCRIPTION OF THE EXAMPLE EMBODIMENTS

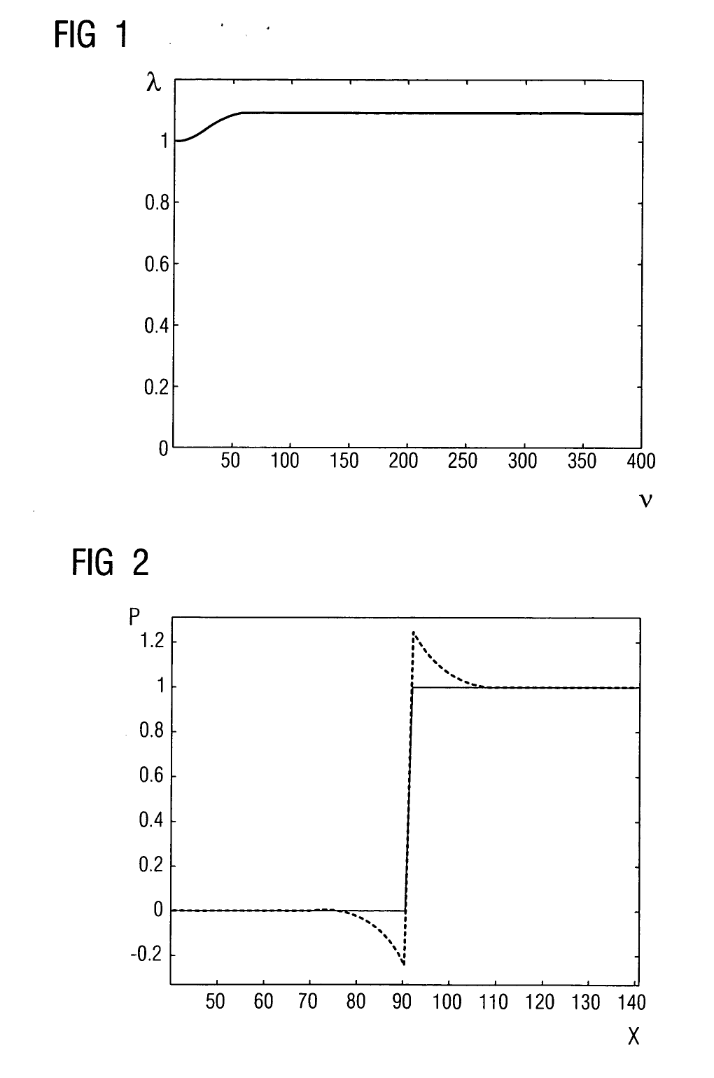

In order to correct particular physical effects, for example scattered radiation, extra-focal radiation, etc., the convolution kernel used for the reconstruction conventionally contains a so-called cupping correction. This is essentially a filter which raises high spatial frequencies, although the steepest gradient lies at relatively low spatial frequencies. Such a filter is represented in FIG. 1, the spatial frequency ν in arbitrary units being plotted linearly on the ordinate and the abscissa representing the size of the filter amplitude λ. At low frequencies ν, the filter amplitude λ also has low values at 1, which first rise continuously to higher frequencies ν, approach a plateau and stay there for the following frequencies.

Besides the intended elimination of physical errors, however, this contribution to the convolution also has a visual effect which is illustrated in FIG. 2. An arbitrary position axis x is plotted on the ordinate, and the abscissa shows the brightness values P of associated pixels of an image. On an ideal edge represented by the solid line, i.e. an arbitrarily sharp contrast jump is applied, an overshoot is generated by the cupping correction as represented by the dashed curve. This overshoot behavior positively influences the visibility for the human eye. This effect can in principle be modulated so that virtually no increase of the noise amplitude takes place. In particular, this is advantageous for the low contrasts.

Yet since the characteristic of the cupping function in the aforementioned application is dictated by the required correction of the physical errors, this effect cannot be adjusted arbitrarily. Amplification of the cupping correction also leads inevitably to undesired overshoots at edges with a high contrast, the strength of the effect being proportional to the contrast.

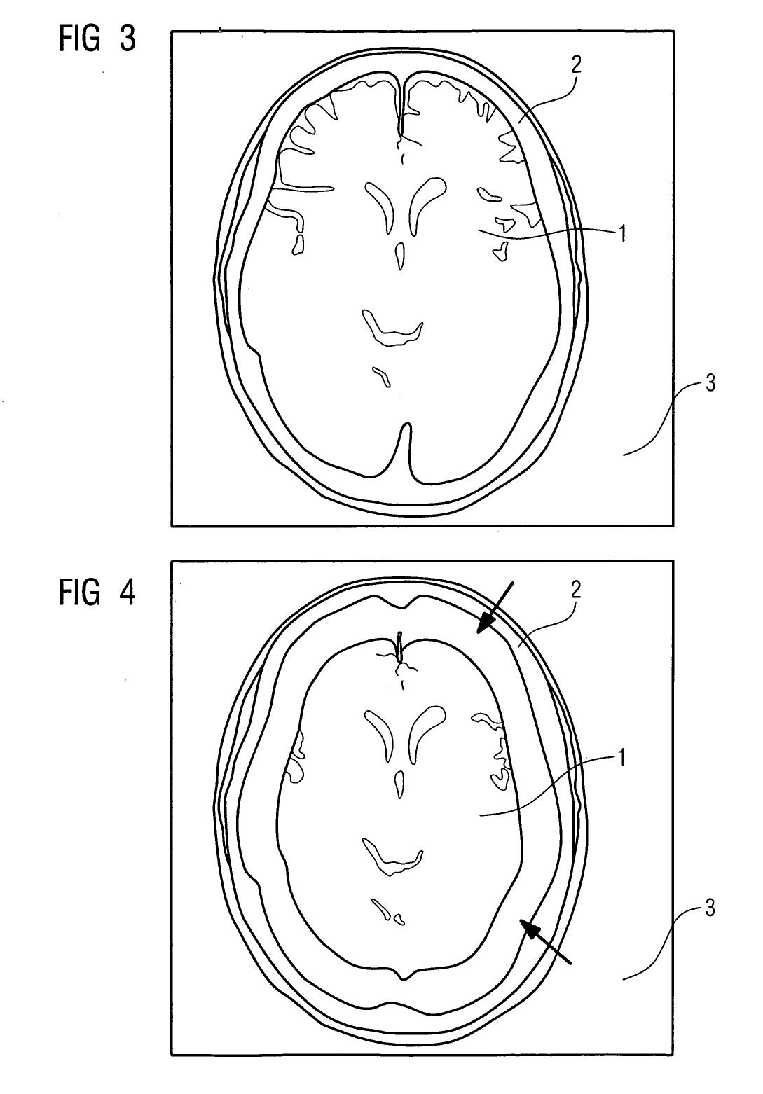

An example of such filtering is shown in the two FIGS. 3 and 4, the soft substructure being denoted by 1, the bone structure by 2 and the air region by 3. FIG. 3 shows an unfiltered CT section image of a skull recording, while in FIG. 4 this recording has been processed by a strong cupping correction in order to be able to see the soft substructure of the brain better. In this case, filtering was carried out by an isotropic 2D filter with a radial frequency characteristic, as represented in FIG. 1.

Consequently, it can be seen that although the centrally imaged soft subregion can be seen better in FIG. 4 owing to the improved contrast of individual structures, this improvement is nevertheless obtained at the cost of the peripheral region toward the bone structures which, owing to the aforementioned overshoot behavior, generate a broad black edge—highlighted by arrows—which in fact overlap the soft substructures.

In the case of neurological studies, the CT values of the soft sub-tissue to be examined lie in a limited interval. It is therefore an object of at least one embodiment of the invention to enhance the contrast with the aid of edge overshoots in this CT value range while, at the same time, preventing these overshoots in the transition region to the bone.

According to an underlying inventive concept of at least one embodiment, the following procedure is for example proposed so as to improve the known method:

I. In order to avoid the undesired effects, the pixel values are mapped with the aid of nonlinear scaling G into a new value interval, the new interval having a smaller brightness range than the original image B. Let G be a monotonic function. Let the pixel values of the original image be I(x,y).

II. The rescaled image G(B) is then convoluted by using an isotropic 2D filter F with a filter characteristic according to FIG. 1, which gives a new image F(G(B)).

III. Scaling back subsequently takes place with an essentially inverse scaling function H, which leads to an end image E₁=H(F(G(B))), with the pixel values I^{E}₁ (x,y) which already has a substantially improved quality.

IV. In an optional final step, the provisional end image E₁ may be further improved by adaptive superposition with the original image B. Let the pixel values of the final image E₂ then be I′(x,y).

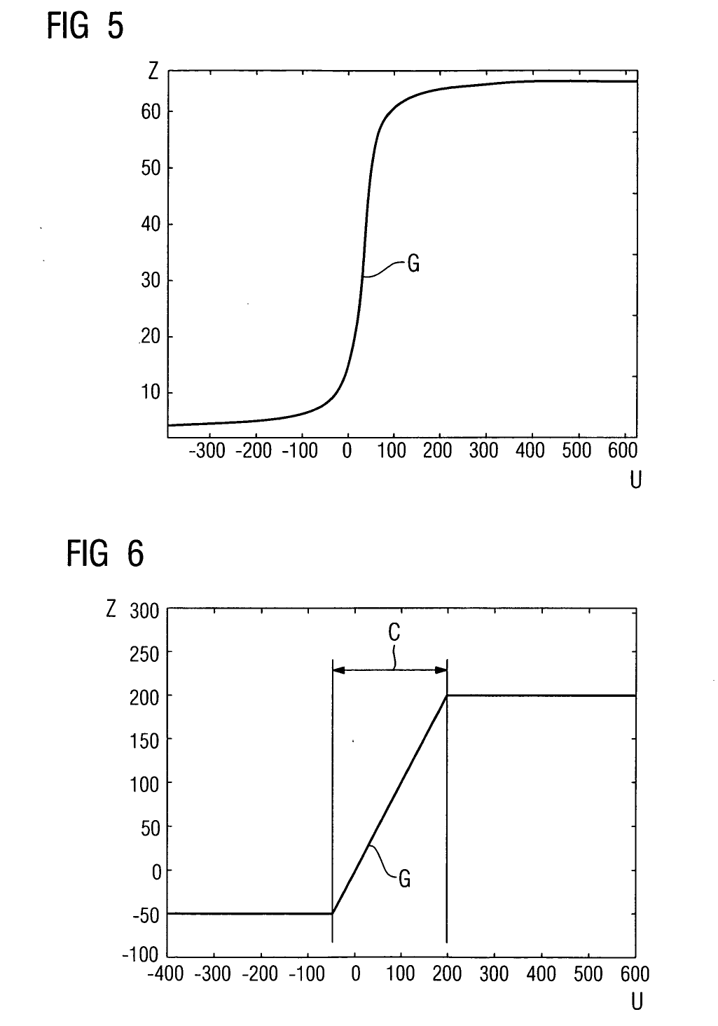

FIG. 5 represents for example a nonlinear and monotonically increasing scaling function G, which transforms the pixel values U of an original image to the target values Z of an intermediate image. This scaling function G is also bijective, as can be seen in FIG. 5. A particular target value Z is uniquely assigned to each pixel value U of the abscissa. In this case, it is also possible to define a unique inverse function H for the resealing, so that H=G⁻¹. When such scaling and resealing functions are used, then no adaptive superposition with the original image is necessary after the application of these functions, although it may optionally be carried out.

Otherwise, i.e. for not strictly monotonic functions, H should fulfill the property “G·H=identical mapping” as described above. An example of this is shown in FIG. 6. The function H is thus to be selected as the inverse of the restriction of G to an interval C.

A further improvement of the method is achieved by the application of weighting by a HU value-dependent function φ for the adaptive superposition of the images. For a pixel I′(x,y), the filtered and rescaled image is then given the weight φ(I(x,y)), while the pixel value of the starting image is admixed with the weight 1−φ(I(x,y)), i.e.:
I′(x,y)=φ(I(x,y))·I^{E}^{₁}(x,y)+[1−φ(I(x,y))]·I(x,y).

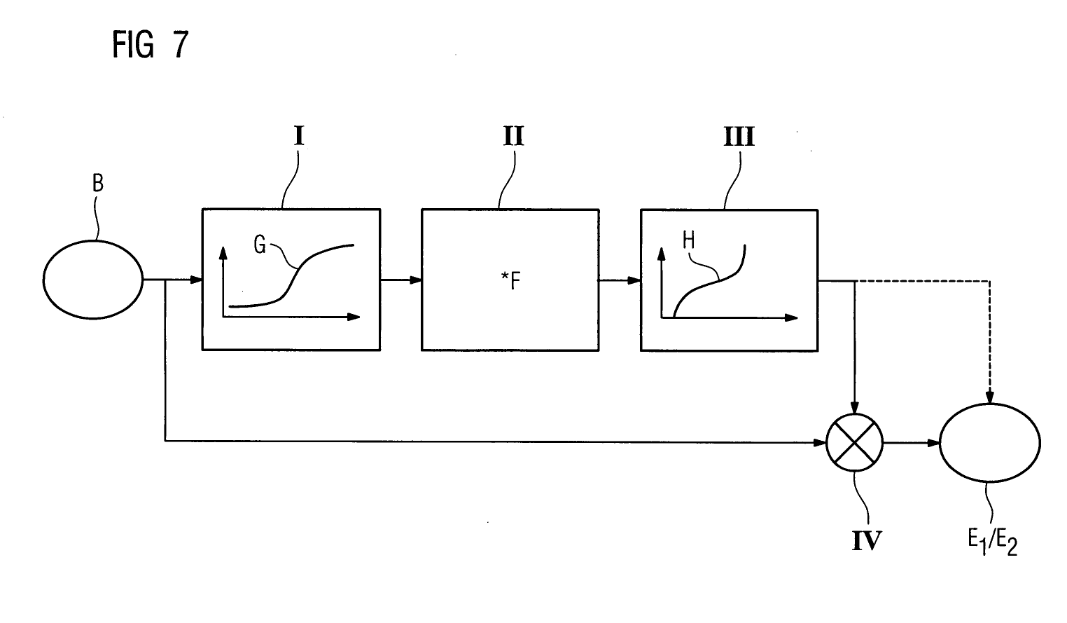

FIG. 7 shows a schematic representation of the method in the form of a flow chart, reference being made to the above-described method steps I: scaling, II: filtering, III: descaling and IV: adaptive superposition. The alternative path represented by dashes between the method step of descaling III and the final image is intended to indicate that a sufficient image quality may sometimes be achieved even without the method step IV.

One dedicated application of the method involves optical improvement of the gray-white differentiation in native CT head scans. Here, the interval of interest lies in the range of between about −20 to +80 HU, and usually even more narrowly between −20 and +50 HU. In the example shown, a linear ramp over the interval [−20, +80] HU according to FIG. 6 was used as the scaling function G. The filter function was selected so that an overshoot of about 30% is generated at the contrast jumps.

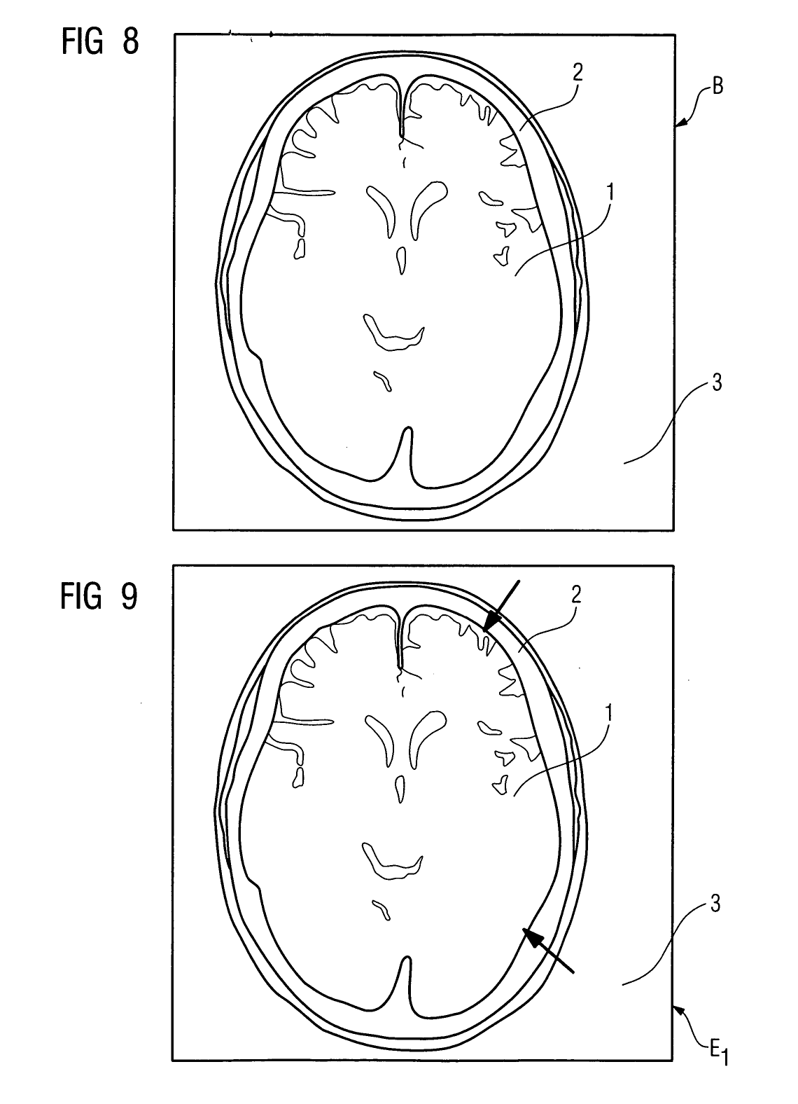

The quality improvement by the method according to the invention is shown in the image of FIG. 9 that derives from the original image of FIG. 8, which is identical to FIG. 3. A significant increase of the contrast in the soft part can be seen in this image. The negative effect of edge overshoots occurring on bone, as in the image of FIG. 4, does not occur.

It should also be pointed out that the increase in the noise amplitude of a filter of the type in FIG. 1 has not been corrected in the examples shown. This effect may, however, be suppressed by combination with a suitable lowpass filter T.

Overall, at least one embodiment of the invention thus represents a method and a device for improving the visual recognition in medical images with a large brightness range by electronic manipulation of the represented brightness values, the image having regions with essentially two different brightness intervals. By application of nonlinear scaling, followed by contrast enhancement and subsequent resealing of the image values, structures are represented with a richer contrast without having to tolerate quality losses in the region of originally strong contrasts.

It should be understood that the aforementioned features of the invention may be used not only in the respectively indicated combination but also in other combinations or individually, without thereby departing from the scope of the invention.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for improving visual recognition in medical images with a brightness range, wherein the image includes at least a first brightness interval corresponding to bone structure in the image and a second brightness interval corresponding to relatively soft substructure, the method comprising:
mapping an original image with pixel values by nonlinear scaling onto a first intermediate image, so that the contrast of the first brightness interval approximates the contrast of the second brightness interval and a modified first brightness interval is obtained from the first brightness interval;
applying a contrast enhancing filter to the first intermediate image to obtain a second intermediate image; and
applying nonlinear resealing to the second intermediate image, raising the modified first brightness interval again with respect to its contrast and generating a first result image.

2. The method as claimed in claim 1, wherein a second result image is generated by adaptive superposition from the first result image and the original image.

3. The method as claimed in claim 1, wherein a two-dimensional filter is used as the filter.

4. The method as claimed in claim 1, wherein an isotropic filter is used as the filter.

5. The method as claimed in claim 1, wherein a filter whose filter amplitude begins low in a lower spatial frequency range, increases monotonically to higher spatial frequencies, approaches a maximum value and then continues constantly for the higher spatial frequencies, is used as the filter.

6. The method as claimed in claim 1, wherein the nonlinear scaling includes scalings which are inverses of each other.

7. The method as claimed in claim 1 wherein the nonlinear scaling includes scalings G and H which fulfill the property G·H=identity.

8. The method as claimed in claim 2, wherein HU value-dependent weighting is carried out in the adaptive superposition of the images.

9. The method as claimed in claim 8, wherein the adaptive superposition with HU-dependent weighting is carried out according to the following formula, wherein original image pixel values are represented by (I(x,y)) and wherein result image pixel values are represented by (I^{E}₁(x,y)),
I′(x,y)=φ(I(x,y))·E^{E}^{₁}(x,y)+[1−φ(I(x,y))]·I(x,y).

10. The method as claimed in claim 1, wherein the second brightness interval remains unchanged by the nonlinear scaling.

11. The method as claimed in claim 1, wherein the image treated has a third brightness interval which corresponds to the recording of air, and this third brightness interval is treated similarly as the first brightness interval.

12. The method as claimed in claim 1, wherein an extra lowpass filter is used in addition to the filter.

13. The method as claimed in claim 1, wherein the second brightness interval lies in an interval of HU values from −20 to +80 HU, the first brightness interval containing the HU values lying below those of the second interval.

14. A device for improving visual recognition in medical images with a brightness range, comprising at least one of program and program modules for carrying out the method as claimed in claim 1.

15. The method as claimed in claim 2, wherein a two-dimensional filter is used as the filter.

16. The method as claimed in claim 2, wherein an isotropic filter is used as the filter.

17. The method as claimed in claim 2, wherein a filter whose filter amplitude begins low in a lower spatial frequency range, increases monotonically to higher spatial frequencies, approaches a maximum value and then continues constantly for the higher spatial frequencies, is used as the filter.

18. The method as claimed in claim 2, wherein the second brightness interval remains unchanged by the nonlinear scaling.

19. The method as claimed in claim 2, wherein the image treated has a third brightness interval which corresponds to the recording of air, and this third brightness interval is treated similarly as the first brightness interval.

20. The method as claimed in claim 11, wherein the second brightness interval lies in an interval of HU values from −20 to +80 HU, the first brightness interval containing the HU values lying below those of the second interval and the third brightness interval containing the HU values lying above those of the second interval.

21. A computer program, adapted to, when executed on a computer, cause the computer to carry out the method as claimed in claim 1.

22. A computer program product, including the computer program of claim 29.

23. A device for improving visual recognition in medical images with a brightness range, wherein the image includes at least a first brightness interval corresponding to bone structure in the image and a second brightness interval corresponding to relatively soft substructure, the method comprising:
means for mapping an original image with pixel values by nonlinear scaling onto a first intermediate image, so that the contrast of the first brightness interval approximates the contrast of the second brightness interval and a modified first brightness interval is obtained from the first brightness interval;
means for applying a contrast enhancing filter to the first intermediate image to obtain a second intermediate image; and
means for applying nonlinear resealing to the second intermediate image, raising the modified first brightness interval again with respect to its contrast and generating a first result image.
